(19) United States
(12) Patent Application Publication
(10) Pub. No.: US 2016/0319817 A1
(43) Pub. Date: Nov. 3, 2016

(54) METHOD OF OPTIMIZING SUPERCHARGER PERFORMANCE

(71) Applicant: Eaton Corporation, Cleveland, OH (US)

(72) Inventor: Matthew Swartzlander, Battle Creek, MI (US)

(21) Appl. No.: 15/210,381

(22) Filed: Jul. 14, 2016

Related U.S. Application Data
(63) Continuation of application No. PCT/US2015/011522, filed on Jan. 15, 2015.
(60) Provisional application No. 61/927,653, filed on Jan. 15, 2014.
(60) Provisional application No. 62/027,755, filed on Jul. 22, 2014.

(51) Int. Cl. F04C 28/28; G01M 15/05; G01M 15/04; F04C 18/12; F02B 33/38

(52) U.S. Cl. CPC F04C 28/28; F04C 18/126; F02B 33/38; G01M 15/042; G01M 15/05; F04C 2240/20; F04C 2270/05

(57) ABSTRACT

A method of optimizing performance of a supercharger for a given application includes determining a desired pressure ratio of supercharger operation for the given application. One of a rotor lead and a rotor speed can be determined based on the given application. The other of the rotor lead and the rotor speed can be determined based on the pressure ratio and the one of the rotor lead and rotor speed. According to other features, the other of the rotor lead and the rotor speed can be determined based on a peak efficiency map.

### CROSS-REFERENCE TO RELATED APPLICATIONS

This application is a continuation of International Application No. PCT/US2015/011522 filed on Jan. 15, 2015 which claims the benefit of U.S. Patent Application No. 61/927,653 filed on Jan. 15, 2014 and U.S. Patent Application No. 62/027,755 filed on Jul. 22, 2014. The disclosures of the above applications are incorporated herein by reference.

### FIELD

The present disclosure relates generally to superchargers and more particularly to a method of optimizing the performance of a supercharger based on a given application.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine. In some examples it may be difficult to optimize peak efficiency of a supercharger based on a given application.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of optimizing performance of a supercharger for a given application includes determining a desired pressure ratio of supercharger operation for the given application. One of a rotor lead and a rotor speed can be determined based on the given application. The other of the rotor lead and the rotor speed can be determined based on the pressure ratio and the one of the rotor lead and rotor speed. According to other features, the other of the rotor lead and the rotor speed can be determined based on a peak efficiency map.

According to various examples, the rotor speed can be about 11,000 RPM based on a desired pressure ratio of 1.4 and a determined rotor lead of about 300 mm. In another example, the rotor speed can be about 7,500 RPM based on a desired pressure ratio of 1.4 and a determined rotor lead of about 400 mm. In other examples, the rotor speed can be about 12,500 RPM based on the desired pressure ratio of 1.6 and a determined rotor lead of about 300 mm. The rotor speed can be about 15,000 RPM based on the desired pressure ratio of 1.8 and a determined rotor lead of 300 RPM. The rotor speed can be about 10,500 RPM based on the desired pressure ratio of 1.8 and a determined rotor lead of 400 mm.

A method of optimizing performance of a supercharger for a given application includes determining a rotor lead based on the given application. A rotor speed is determined based on the given application. A desired pressure ratio of supercharger operation can be determined for the given application based on the determined rotor lead and rotor speed. According to additional features the desired pressure ratio of the supercharger can be determined based on a peak efficiency map.

According to various examples, the desired pressure ratio can be 1.4 for a rotor speed of about 11,000 RPM and a rotor lead of 300 mm. In other examples, the desired pressure ratio can be 1.4 for a rotor speed of about 11,000 RPM and a rotor lead of 300 mm. A desired pressure ratio can be 1.4 for a rotor speed of about 7,500 RPM and a rotor lead of about 400 mm. A desired pressure ratio can be 1.6 for a rotor speed of about 12,500 RPM and a rotor lead of about 300 mm. A desired pressure ratio can be 1.8 for a rotor speed of about 15,000 RPM and a rotor lead of 300 mm.

A method of optimizing performance of a supercharger for a given application can include determining a desired pressure ratio of supercharger operation for the given application based on a peak efficiency map. A rotor speed can be determined based on the given application. A desired rotor lead can be determined based on the determined desired pressure ratio and the determined rotor speed of the given application.

According to various examples, the rotor lead is about 300 mm based on the desired pressure ratio of 1.4 and a determined rotor speed of 11,000 RPM. The rotor lead can be about 400 based on the desired pressure ratio of 1.4 and a determined rotor speed of 7,500 RPM. The rotor lead can be about 300 mm based on the desired pressure ratio of 1.6 and a determined rotor speed of 12,500 RPM. The rotor lead can be about 300 mm based on the desired pressure ratio of 1.8 and a determined rotor speed of 15,000 RPM. The rotor lead can be about 400 mm based on a pressure ratio of 1.8 and a rotor speed of 10,500 RPM.

A supercharger with optimized performance for boosting an engine at a pressure ratio according to one example of the present disclosure includes a housing in which a first rotor and a second rotor are supported to operably rotate at a rotor speed. The first rotor defines a rotor lead having a length. The length of the rotor lead is based on the pressure ratio and the rotor speed at which the first rotor and the second rotor rotate.

According to additional features the first and second rotors are disposed in a pair of parallel, transversely overlapping cylindrical chambers. The first and second rotors are driven at a fixed ratio relative to a crankshaft speed such that a displacement of the supercharger is greater than a displacement of the engine. In one example the rotor lead is about 300 mm based on the pressure ratio of 1.4 and the rotor speed of 11,000 RPM. In another example, the rotor lead is about 400 mm based on the pressure ratio of 1.4 and the rotor speed of 7,500 RPM. In other examples, the rotor lead is about 300 mm based on the pressure ratio of 1.6 and the rotor speed of 12,500 RPM. In another example, the rotor lead is about 300 mm based on the pressure ratio of 1.8 and the rotor speed of 15,000 RPM.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is an exemplary performance map of a supercharger having 0.34 liters of displacement;

FIG. 3 is a performance map of a supercharger having 1.90 liters of displacement;

FIG. 4 is a table illustrating differences of superchargers having various measurements;

FIG. 5 is a side perspective view of a high lead rotor according to one example;

FIG. 6 is a side perspective view of a low lead rotor according to one example;

FIG. 7 is a table illustrating a velocity map for superchargers having various displacements;

FIG. 8 is plot illustrating rotor lead versus rotor speed for superchargers having various displacements;

FIG. 9 is a table illustrating a comparison of superchargers having various displacements mapped for a given isentropic efficiency;

FIG. 10 is a plot illustrating performance of superchargers having various displacements at 1.4 pressure ratio;

FIG. 11 is the plot of FIG. 10 and further illustrating an optimal efficiency provided by a rotor speed;

FIG. 12 is a plot illustrating performance of superchargers having various displacements at 1.6 pressure ratio and further illustrating an optimal efficiency provided by a rotor speed;

FIG. 13 is a plot illustrating performance of superchargers having various displacements at 1.8 pressure ratio and further illustrating an optimal efficiency provided by a rotor speed;

FIG. 14 is a plot illustrating performance of superchargers having various displacements at 2.4 pressure ratio and further illustrating that small units have a peak efficiency outside of the plot range;

FIG. 15 is a plot of pressure ratio versus mass flow for a supercharger having 0.2 liters of displacement;

FIG. 16 is a table illustrating isentropic efficiency at a pressure ratio of 1.4 for superchargers having various displacements;

FIG. 17 is a table illustrating volumetric efficiency at a pressure ratio of 1.4 for superchargers having various displacements;

FIGS. 18-20 illustrates various rotors having 0.41 liters of displacement with different leads and helix angles; and

FIG. 21 illustrates velocity profile adaptation to lead including a lead velocity profile and an air velocity profile;

### DETAILED DESCRIPTION

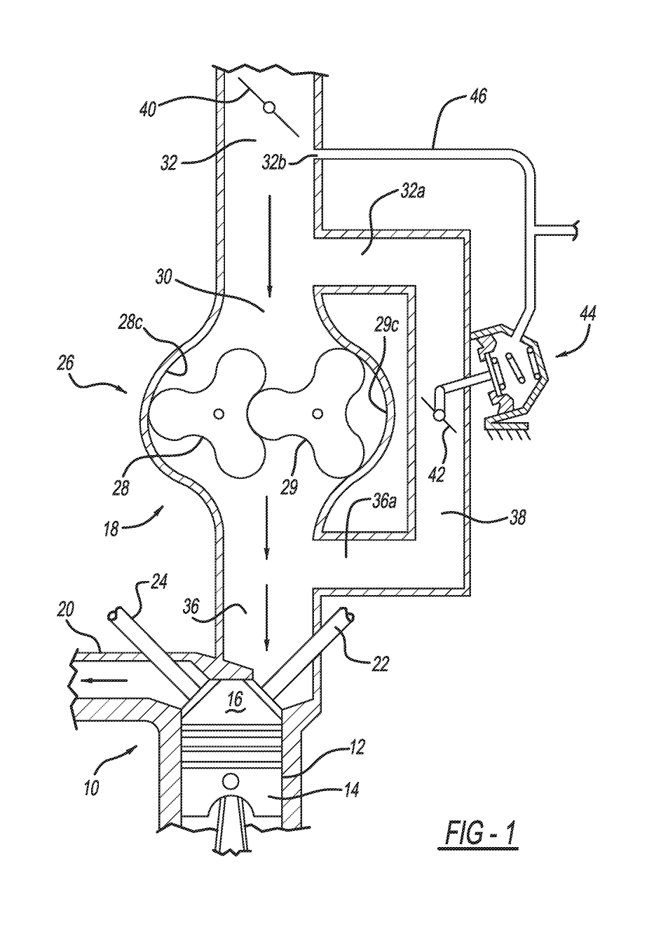

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos. 5,078,583 and 5,893,355, which are expressly incorporated herein by reference. The blower 26 includes a pair of rotors 28 and 29, each of which includes a plurality of meshed lobes. The rotors 28 and 29 are disposed in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The blower 26 can include an inlet port 30 which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

In designing a supercharger for a given application, one goal is to provide a supercharger that offers peak efficiency. In general, thermal efficiency of a supercharger can be defined by how well a supercharger takes air from one state to another state relative to how the temperature rises. In one example a supercharger's performance can be compared to the ideal gas law or PV=nRT. If perfect compression existed in a supercharger, the supercharger would be considered 100% efficient. In application, a goal is to attain efficiency as close to 100% at some speed and some pressure ratio.

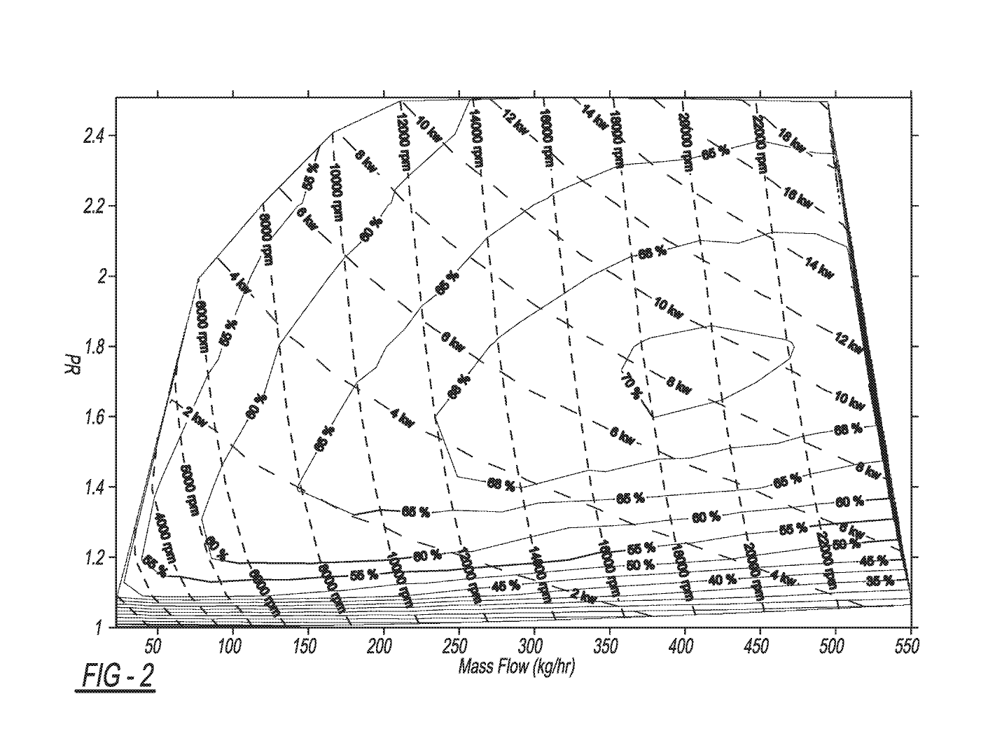

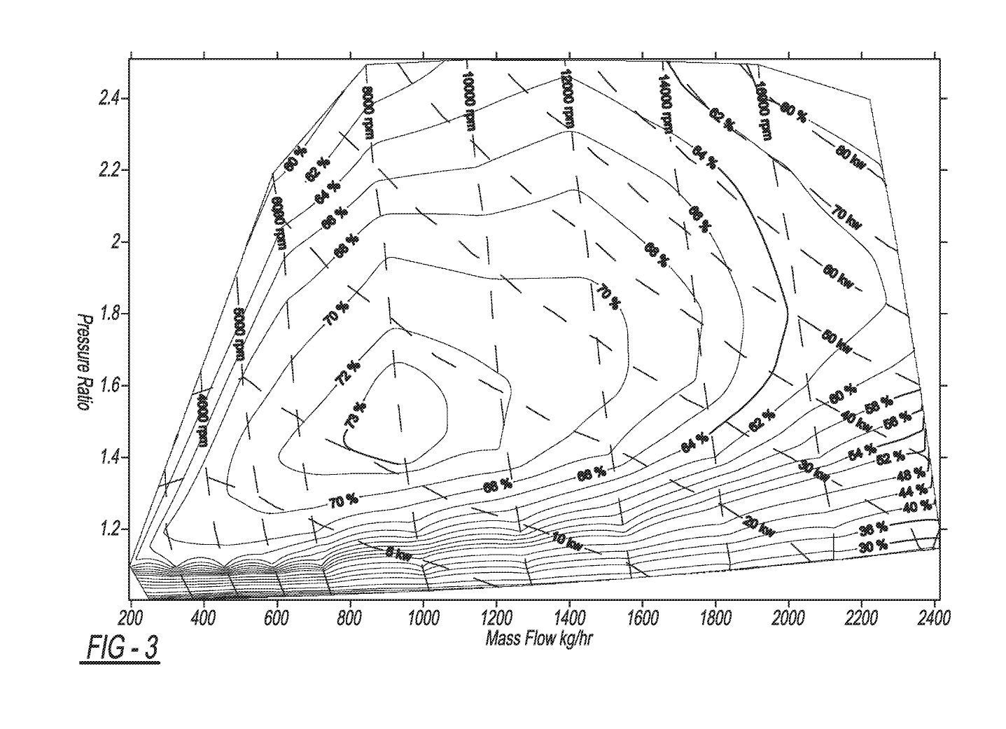

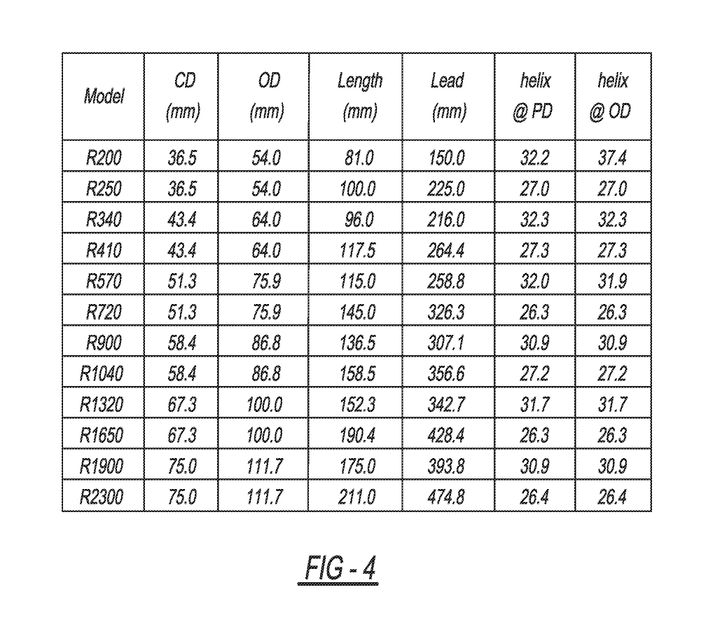

With reference to FIG. 2, a performance map for an R340 supercharger is shown. The performance map plots pressure ratio against rotor speed. A pressure ratio denotes an outlet air pressure divided by an inlet air pressure of the supercharger. An R340 supercharger is used to denote a supercharger that makes 0.34 liters of air displacement per each revolution. As used herein, the numerical suffix after the “R” represents a liter of air displacement divided by 1000. FIG. 3 shows a performance map for an R1900 supercharger. FIG. 4 is a table that illustrates various dimensions for a given supercharger. A lead of a supercharger can be a linear distance required to make one complete rotation around the rotor.

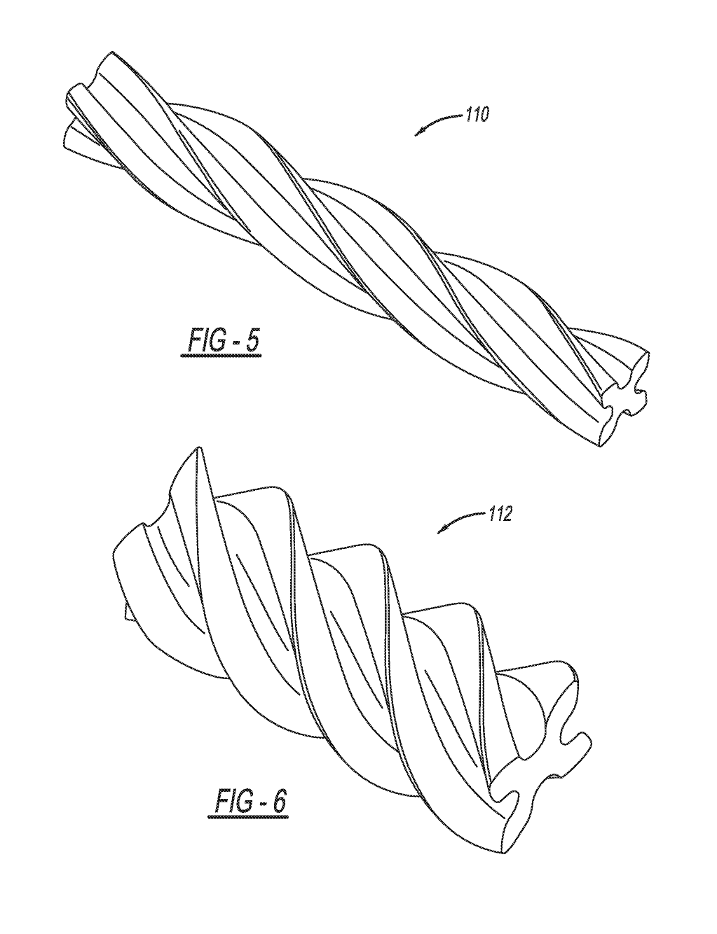

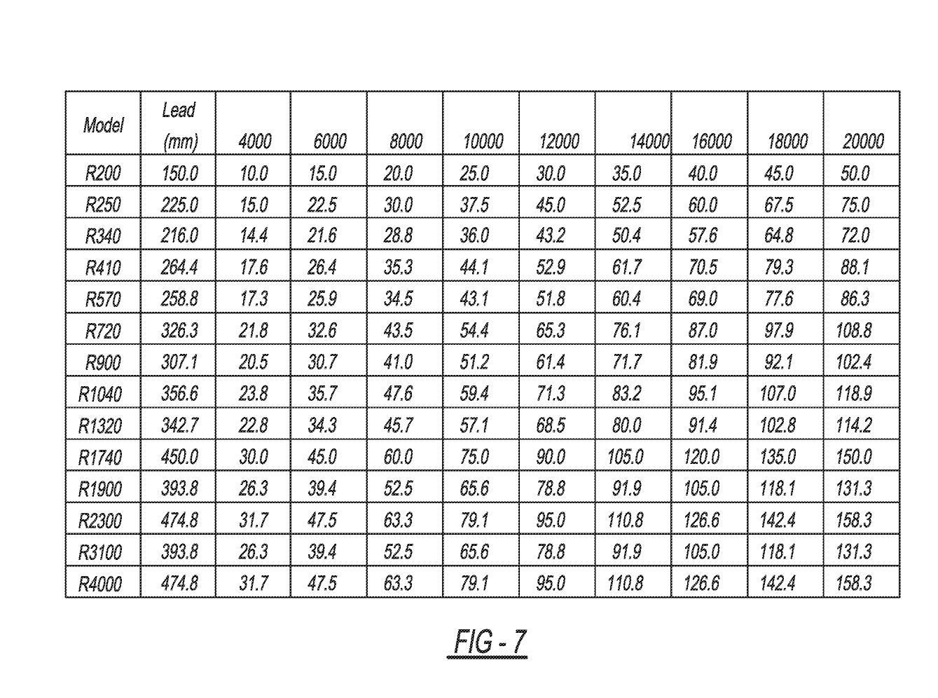

FIGS. 5 and 6 illustrate a pair of rotors 110 and 112. The rotor 110 has a relatively high lead and low helix whereas the rotor 112 has a relatively low lead and high helix. As is known, rotational speed multiplied by lead equals axial velocity. FIG. 7 is a table illustrating a velocity map for a range of superchargers. Again the model identifies superchargers having various liters of air output per revolution. The first horizontal row identifies an RPM of the rotor. The body of the table illustrates a velocity of air in meters/second. For example, the model R200 (0.2 liters of air output per revolution) rotating at 6000 RPM will move air at 15 meters per second.

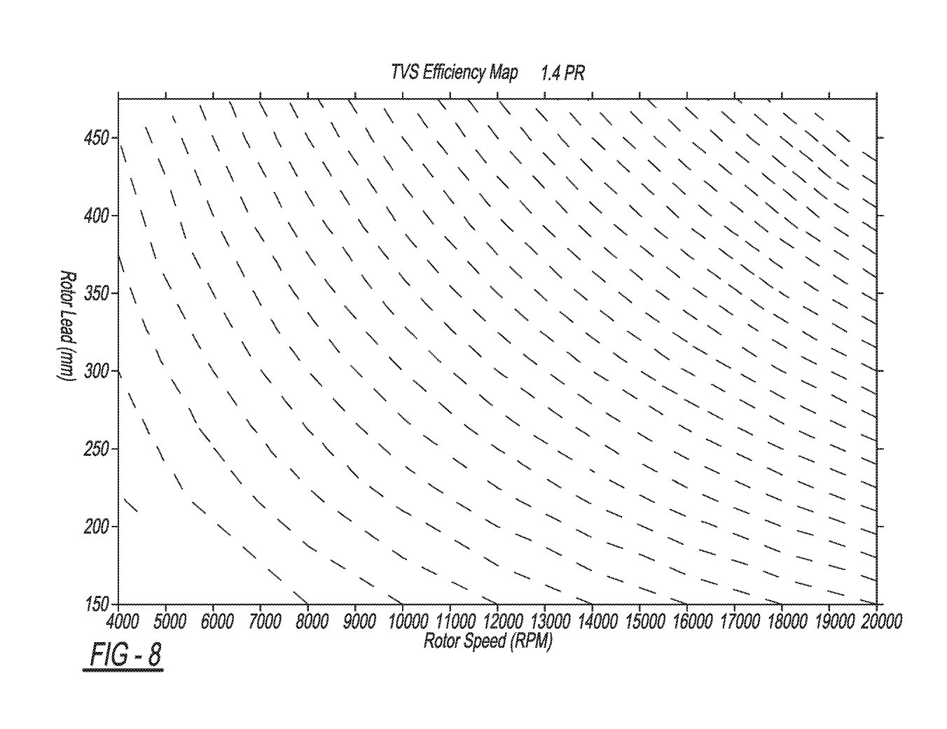

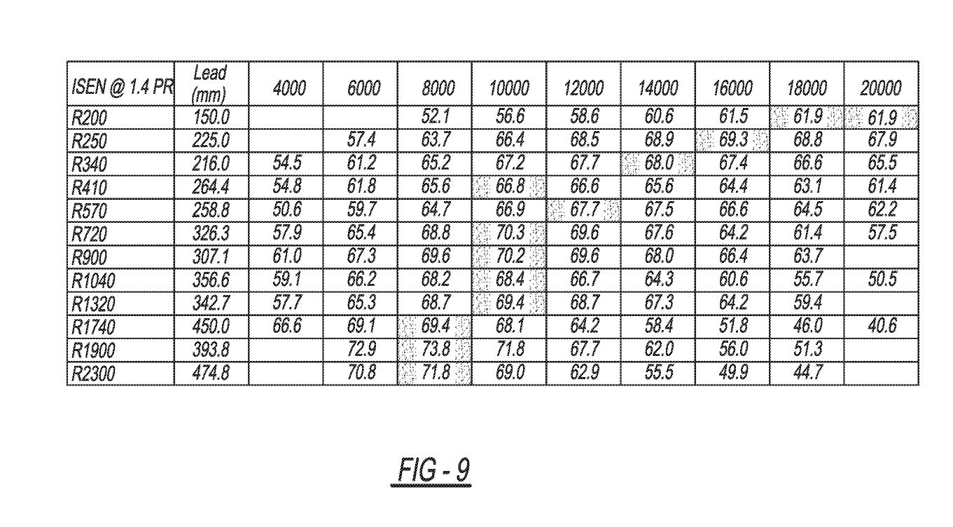

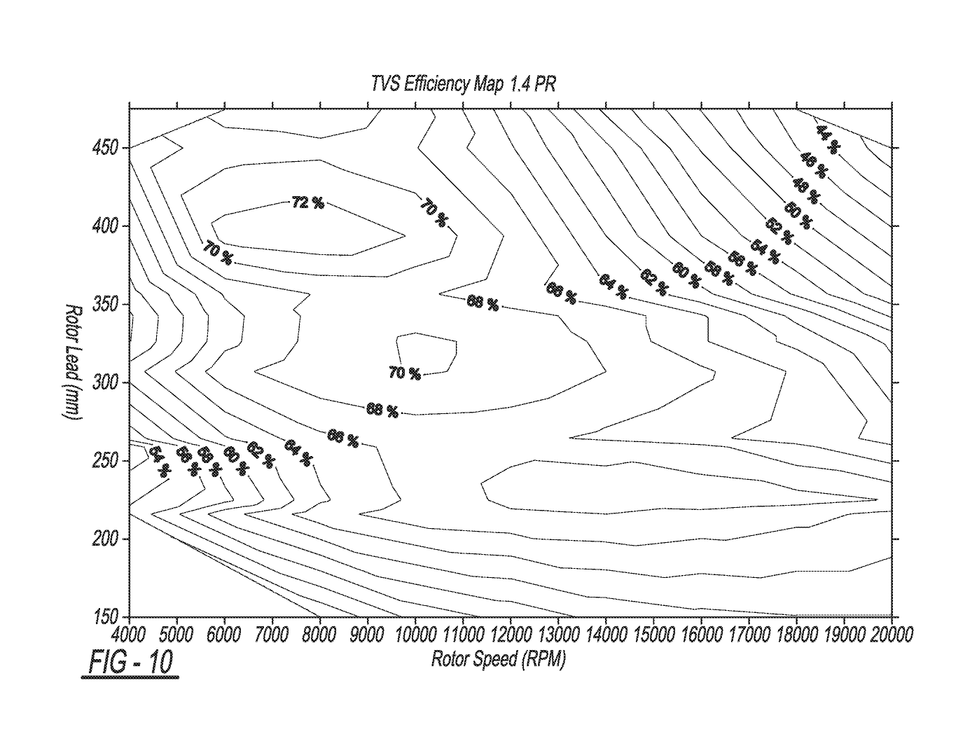

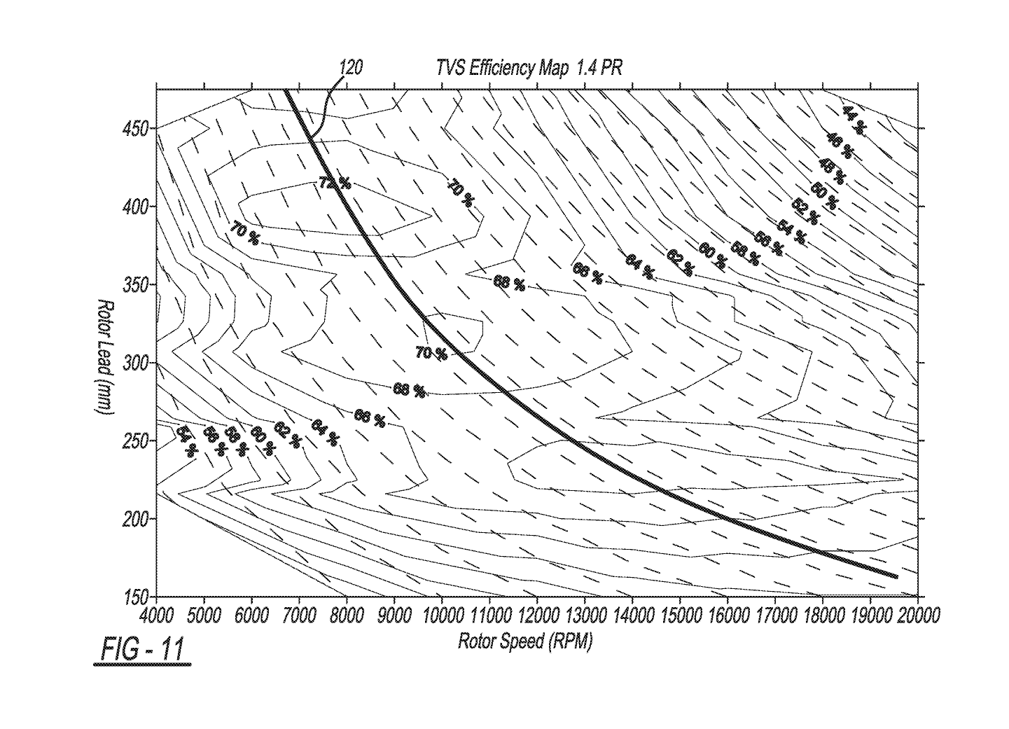

FIG. 8 is a plot illustrating the speed of a lead profile. FIG. 9 is a table that shows various supercharger models (R200-R2300) set for a pressure ratio of 1.4. The highest isentropic efficiencies are shaded. For example, the R410 supercharger achieves its highest efficiency of 66.8 at 10,000 rotor RPM. FIG. 10 is an efficiency map for various supercharger models set for a pressure ratio of 1.4. The islands identify highest thermal efficiencies. For example, a supercharger having a lead of 400, the highest efficiency of around 72% occurs around 7,000 rotor RPM. FIG. 11 identifies bold line 120 at about a determined m/s for a pressure ratio of 1.4. The bold line 120 signifies the highest thermal efficiencies are realized for lead speed of about a determined m/s.

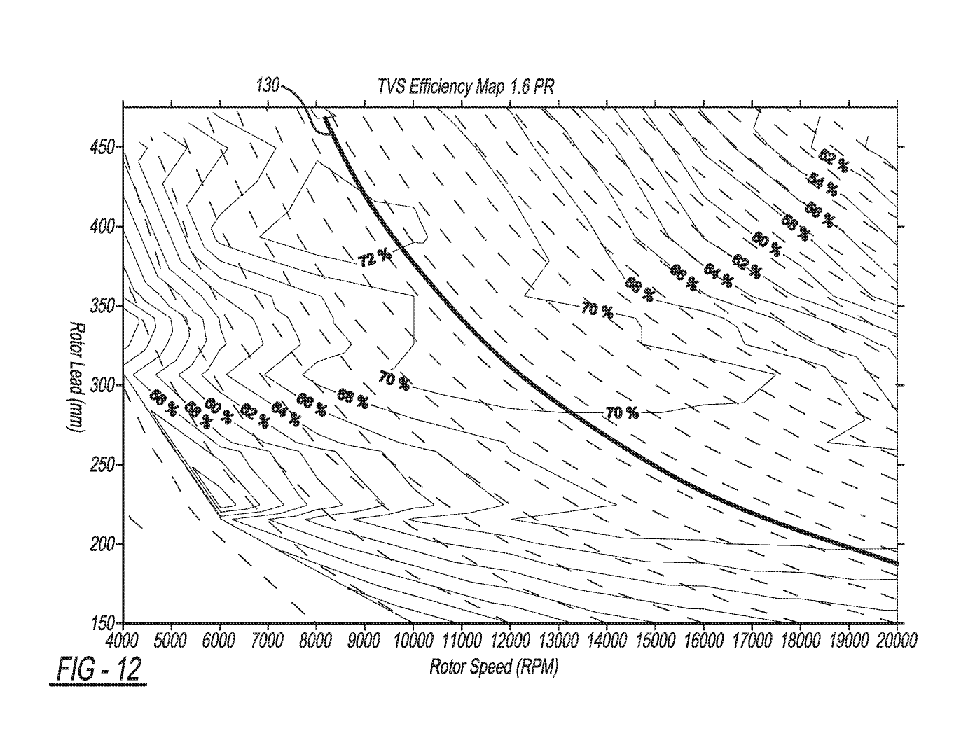

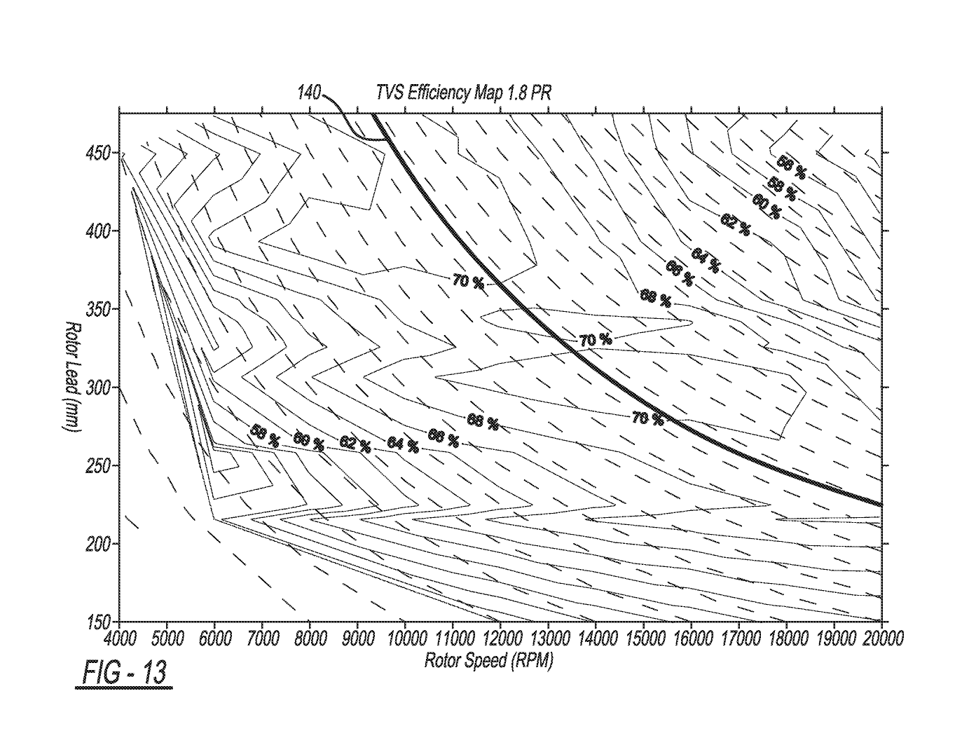

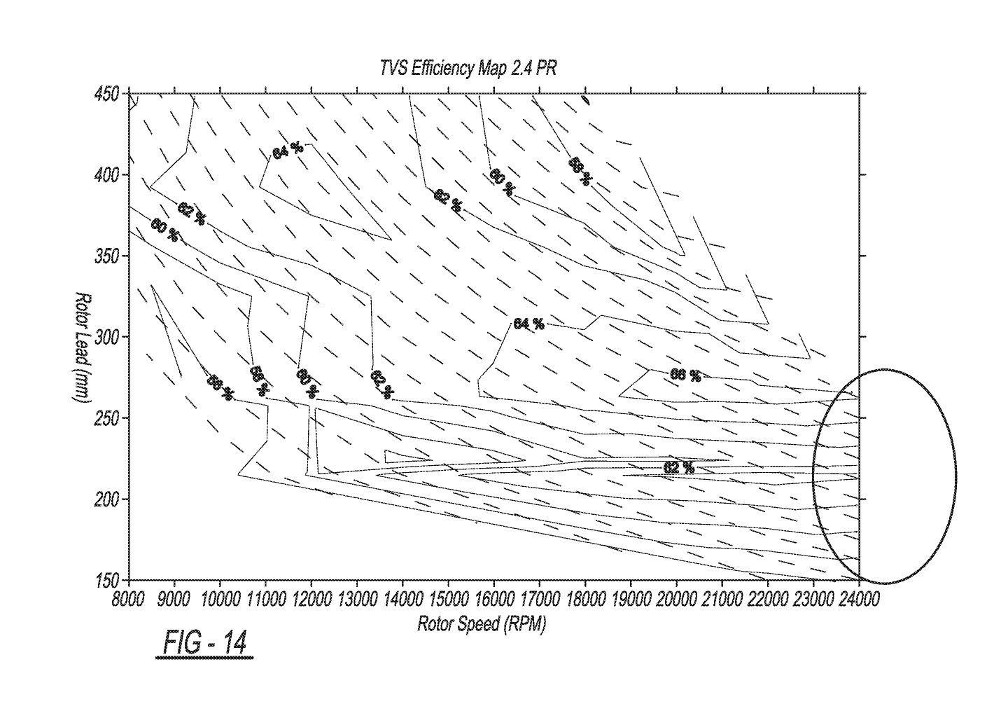

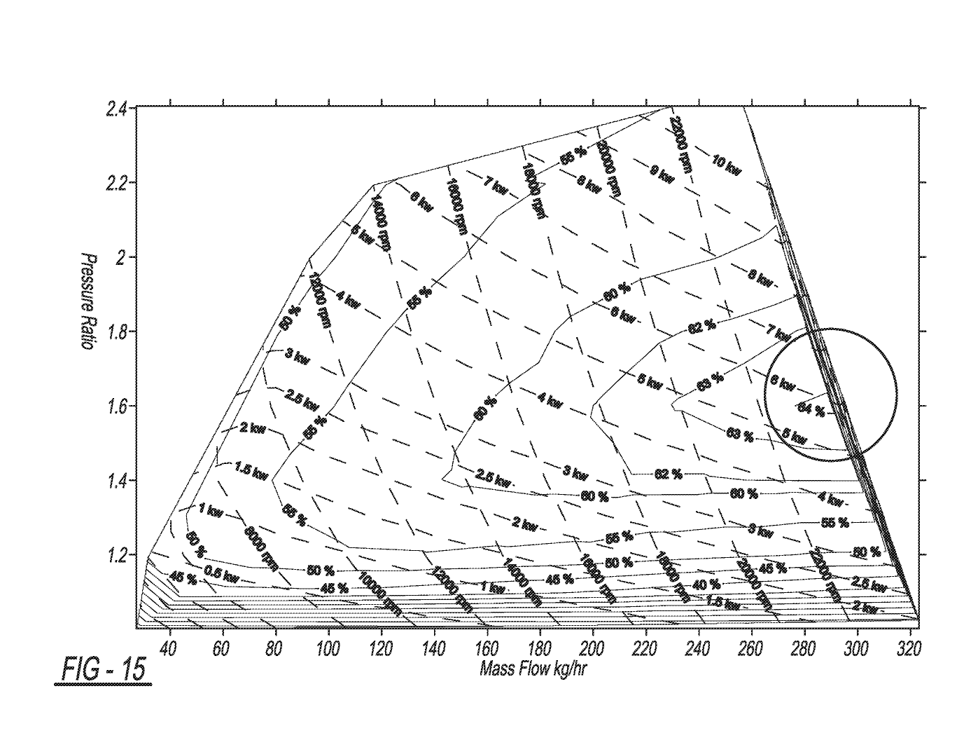

FIG. 12 is a similar graphical representation as FIG. 11 but for superchargers set for 1.6 pressure ratios. In this example, the highest thermal efficiencies are realized at the bold line 130, or for a lead speed of about a determined m/sec. FIG. 13 is another graphical representation where the superchargers are set for 1.8 pressure ratio. In this example, the highest thermal efficiencies are realized at bold line 140, or for a lead speed of about a determined m/sec. FIG. 14 is another graphical representation where the superchargers are set for 2.4 pressure ratio. In this example, the highest efficiencies for the smallest units are outside the range of the plot. In other words, the highest efficiencies require speeds above 24,000 rotor RPM. In general, referring to FIGS. 11-14, the higher the desired pressure ratio, the higher the lead speeds will need to be to reach the peak efficiencies. FIG. 15 illustrates a performance map of pressure ratio versus mass air flow. The peak efficiency is on the edge of normal operating range.

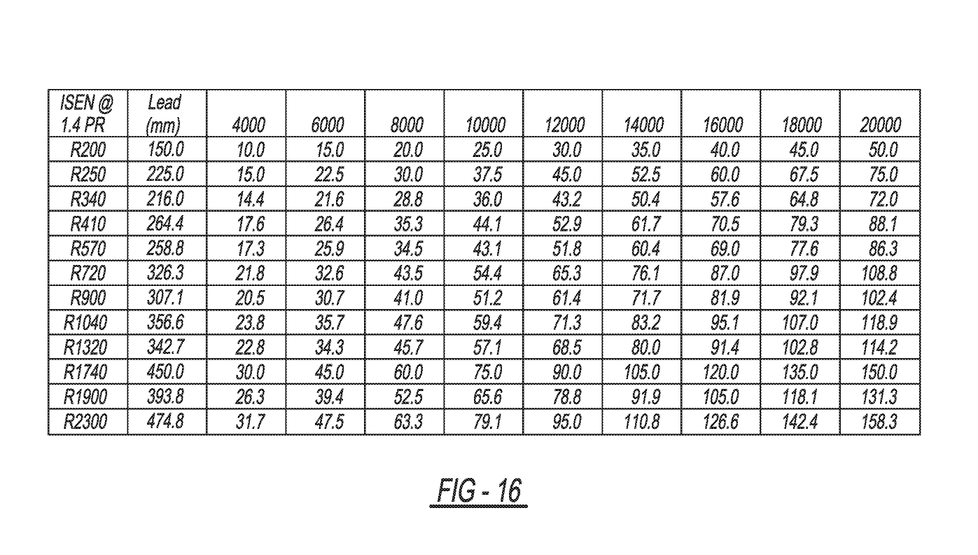

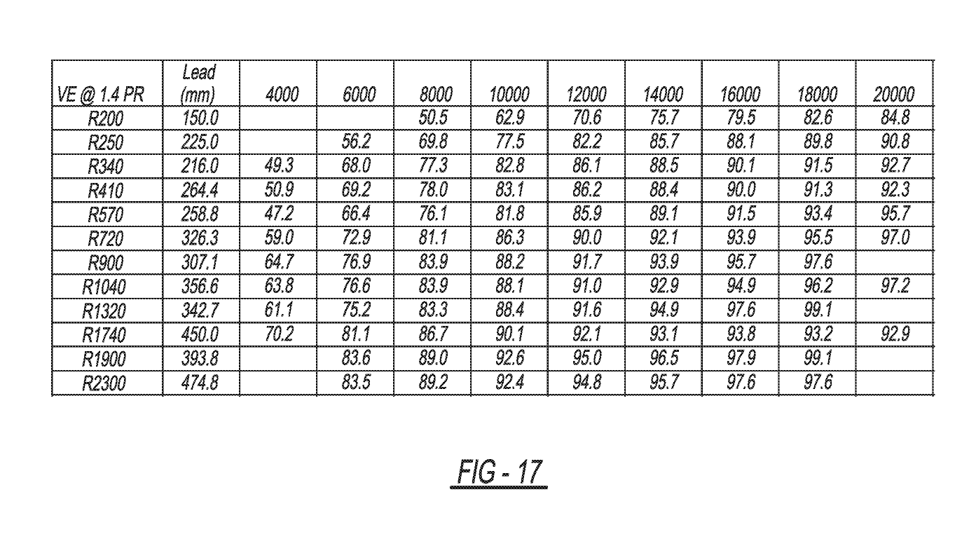

FIGS. 16 and 17 are tables indicating various superchargers running at various RPM's and attaining various lead velocities. Certain conclusions can be made from the above FIGS. In general, the lead controls the location of the peak efficiency in the supercharger speed range. Moreover, using the tables shown in FIGS. 16 and 17 along with the maps shown in FIGS. 11-13, a supercharger can be designed to attain a peak efficiency (bold lines, FIGS. 11-13) based on a given rotor speed and rotor lead. Explained further, should a particular supercharger application require operation at a particular pressure ratio, the rotor lead and rotor speed can be chosen to provide a supercharger that reaches peak efficiency. For example, should a supercharger application require operation at 1.4 pressure ratio (FIG. 11), and a rotor lead of 300 mm, the supercharger should be configured for operation at about 11,000 RPM. Similarly, should the supercharger require operation at 1.4 pressure ratio, and a rotor lead of 400 mm, the supercharger should be configured for operation at about 7,500 RPM. Again, the goal is to align with the peak efficiency bold line 120 that extends through the peak efficiency islands.

In other examples, referring to a supercharger application that requires operation at 1.6 pressure ratio (FIG. 12), and a rotor lead of 300 mm, the supercharger should be configured for operation at about 12,500 RPM. With continued reference to FIG. 12, according to other examples of a supercharger application that requires operation at 1.6 pressure ratio and a rotor lead of 400 mm, the supercharger should be configured for operation at about 9,500 RPM.

Turning now to FIG. 13, referring to a supercharger application that requires operation at 1.8 pressure ratio and a rotor lead of 300 mm, the supercharger should be configured for operation at about 15,000 RPM. With continued reference to FIG. 13, according to other examples of a supercharger application that requires operation at 1.8 pressure ratio and a rotor lead of 400 mm, the supercharger should be configured for operation at about 10,500 RPM. It will be appreciated that for all these examples shown such as in FIGS. 11-13, with two variables known (two of pressure ratio, rotor speed and rotor lead), the third can be determined based on the efficiency maps.

In some instances, a small unit's lead can be too low to reach peak efficiency at higher pressure ratios. Modifying a helix angle can broaden the efficiency map. Efficiencies at high speed indicate velocities of 120 m/s can be too high. Lead should be low enough as to not reach such axial speeds in the RPM range.

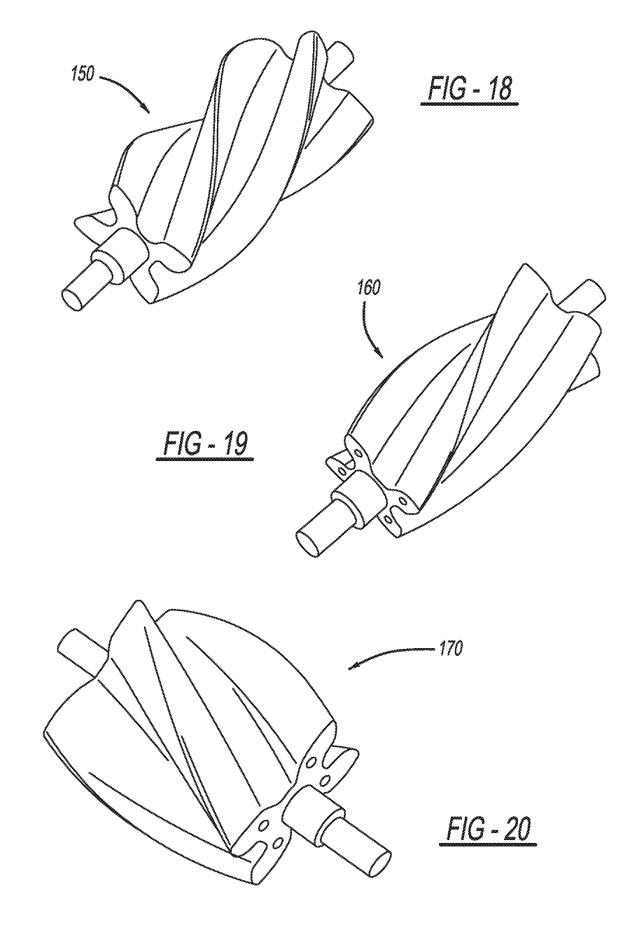

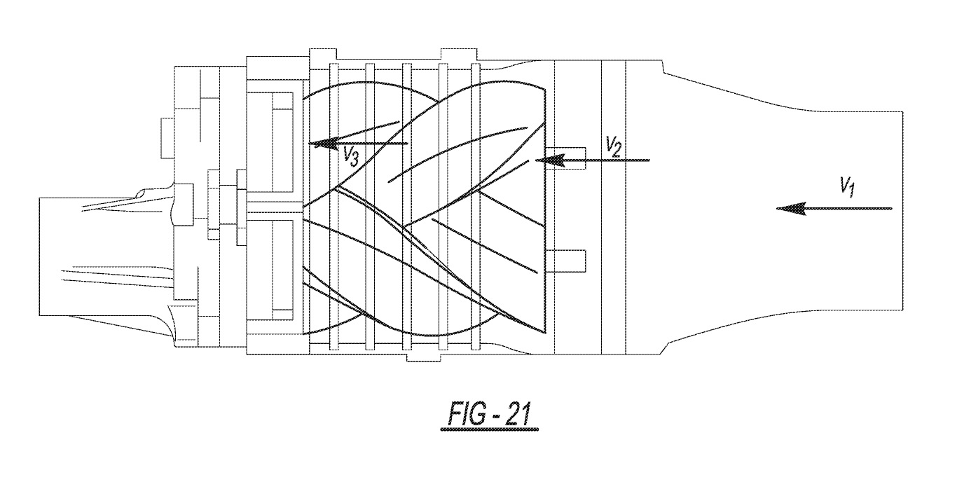

Referring to FIGS. 18-20, various rotors are shown. Rotor 150 (FIG. 18) is an R410 having a 264 mm lead and a 27 degree helix. Rotor 160 (FIG. 19) is an R410 having a 380 mm lead and a 19 degree helix. Rotor 170 (FIG. 20) is an R410 having a 380 mm lead and a 30 degree helix. With reference to FIG. 21, a supercharger is shown having velocities V₁, V₂ and V₃. The velocity V₁ identifies the duct air speed based on the area of the supercharger and the flow rate. The velocity V₂ identifies the lead rotational speed. In general, V₁ is lower than V₂. The velocity V₃ is zero where the air engages the bearing plate. Once the air engages the bearing plate the velocity is converted to pressure.

The foregoing description of the embodiments has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A method of optimizing performance of a supercharger for a given application, the method comprising:
determining a desired pressure ratio of supercharger operation for the given application;
determining one of a rotor lead and a rotor speed based on the given application; and
determining the other of the rotor lead and rotor speed based on the desired pressure ratio and the one of the rotor lead and rotor speed.

2. The method of claim 1 wherein the other of the rotor lead and rotor speed is determined based on a peak efficiency map.

3. The method of claim 2, further comprising determining the rotor speed based on the desired pressure ratio and the determined rotor lead.

4. The method of claim 3 wherein the rotor speed is about 11,000 RPM based on the desired pressure ratio of 1.4 and a determined rotor lead of about 300 mm.

5. The method of claim 3 wherein the rotor speed is about 7,500 RPM based on the desired pressure ratio of 1.4 and a determined rotor lead of about 400 mm.

6. The method of claim 3 wherein the rotor speed is about 12,500 RPM based on the desired pressure ratio of 1.6 and a determined rotor lead of about 300 mm.

7. The method of claim 3 wherein the rotor speed is about 15,000 RPM based on the desired pressure ratio of 1.8 and a determined rotor lead of 300 mm.

8. The method of claim 3 wherein the rotor speed is about 10,500 RPM based on the desired pressure ratio of 1.8 and a determined rotor lead of 400 mm.

9. A method of optimizing performance of a supercharger for a given application, the method comprising:
determining a rotor lead based on the given application;
determining a rotor speed based on the given application; and
determining a desired pressure ratio of supercharger operation for the given application based on the determined rotor lead and the rotor speed.

10. The method of claim 9 wherein the desired pressure ratio of the supercharger is determined based on a peak efficiency map.

11. The method of claim 10 wherein the desired pressure ratio is 1.4 for a rotor speed of about 11,000 RPM and a rotor lead of 300 mm.

12. The method of claim 10 wherein the desired pressure ratio is 1.4 for a rotor speed of about 7,500 RPM and a rotor lead of about 400 mm.

13. The method of claim 10 wherein the desired pressure ratio is 1.6 for a rotor speed of about 12,500 RPM and a rotor lead of about 300 mm.

14. The method of claim 10 wherein the desired pressure ratio is 1.8 for a rotor speed of about 15,000 RPM and a rotor lead of 300 mm.

15. A method of optimizing performance of a supercharger for a given application, the method comprising:
determining a desired pressure ratio of supercharger operation for the given application based on a peak efficiency map;
determining a rotor speed based on the given application; and
determining a desired rotor lead based on the determined desired pressure ratio and the determined rotor speed of the given application.

16. The method of claim 15 wherein the rotor lead is about 300 mm based on the desired pressure ratio of 1.4 and a determined rotor speed of 11,000 RPM.

17. The method of claim 15 wherein the rotor lead is about 400 mm based on the desired pressure ratio of 1.4 and a determined rotor speed of 7,500 RPM.

18. The method of claim 15 wherein the rotor lead is about 300 mm based on the desired pressure ratio of 1.6 and a determined rotor speed of 12,500 RPM.

19. The method of claim 15 wherein the rotor lead is about 300 mm based on the desired pressure ratio of 1.8 and a determined rotor speed of 15,000 RPM.

20. The method of claim 15 wherein the rotor lead is about 400 mm based on a pressure ratio of 1.8 and a rotor speed of 10,500 RPM.
